(19) United States
(12) Patent Application Publication
(10) Pub. No.: US 2016/0151897 A1
(43) Pub. Date: Jun. 2, 2016

(54) Tire Stud Removal Tool with Different Fulcrum Points for Use on Tires of Varying Tread Wear

(71) Applicant: Randy Daneliuk, Flin Flon (CA)

(72) Inventor: Randy Daneliuk, Flin Flon (CA)

(21) Appl. No.: 14/735,220

(22) Filed: Jun. 10, 2015

Related U.S. Application Data
(60) Provisional application No. 62/010,002, filed on Jun. 10, 2014.

(51) Int. Cl. B25B 27/00; B25C 11/00

(52) U.S. Cl. CPC B25B 27/0035; B25C 11/00

(57) ABSTRACT

A tire stud removal tool features a handle and working tip attached to opposing ends of a shaft, and a hollow socket at a free end of the working tip. At least one fulcrum member protrudes outwardly from the elongated shaft at a position adjacent to the working tip. The one or more fulcrum members define a first fulcrum point nearer to the free end of the working tip for leveraging the tool against the pliable tread of generally unworn studded tire, and the second fulcrum point further from the working tip for leveraging the tool against the stiffer tread of a notably worn studded tire. The second fulcrum point resides at an outer end of a sloped surface that faces toward the free end of the working tip and slopes away from the free end of the working tip toward the handle in an outward direction.

### CROSS REFERENCE TO RELATED APPLICATIONS

This application claims benefit under 35 U.S.C. 119(e) of Provisional Application Ser. No. 62/010,002, filed Jun. 10, 2014.

### FIELD OF THE INVENTION

The present invention relates generally to tools for prying studs from studded winter tires, and more particularly to such a tool having a socket-equipped working tip on an elongated shaft on which two different fulcrum points are provided for use of a particular one of the fulcrums for prying a stud from the tire depending on the tire's level of tread wear.

### BACKGROUND

A number of tools have been disclosed in the prior art for the purpose of adjusting or removing studs from studded tires, including those disclosed in U.S. Pat. Nos. 3,400,443, 3,458,895, 4,255,842 and D682057, each of which employs a hollow cylindrical working tip that is forced over the shaft of a tire stud.

U.S. Pat. No. 3,388,451 discloses another socket-tipped tire stud tool, but used for installing, not removing, tire studs.

U.S. Pat. No. 4,097,021 discloses a tire stud puller that instead employs a pair of pivotally joined plier jaws to grip the tire stud, and adds a selectively deployable lever arm to create a fulcrum point for contact against the crown of the tire to create leverage during pulling of the stud. U.S. patent discloses a nail puller that likewise features pivotal gripping jaws and a single lever or fulcrum arm.

Applicant has developed unique stud pulling tools for leveraged prying of tire studs in a manner that accommodates for varying tread depths from one tire to the next to minimize the effect of such varying tread conditions on the operability of the tool.

### SUMMARY OF THE INVENTION

According to one aspect of the invention, there is provided A tool for removing studs from a tire, the tool comprising:

an elongated shaft extending in a longitudinal direction along a longitudinal axis;

a handle attached to the elongated shaft at first end thereof;

a working tip on the elongated shaft at a second end thereof lying opposite the first end in the longitudinal direction;

a hollow socket extending axially into the working tip in the longitudinal direction from a free end of the working tip that lies opposite the handle in the longitudinal direction;

a first fulcrum point carried on the shaft at a first radial distance outward from the shaft and at a first axial distance in the longitudinal direction from the free end of the working tip; and

a second fulcrum point carried on the shaft at a second radial distance outward from the shaft and at a second axial distance in the longitudinal direction from the free end of the working tip, the second axial distance between greater than the first axial distance so as to situate the second fulcrum point further form the free end of the working tip than the first fulcrum point.

Preferably, each fulcrum point is defined by a corner edge defined between two surfaces of a fulcrum member attached to the shaft.

In a preferred single-fulcrum embodiment, the first and second fulcrum points are defined by a same fulcrum member attached to the shaft.

In a preferred single-fulcrum embodiment, the fulcrum member spans circumferentially around the elongated shaft.

In the preferred single-fulcrum embodiment, the first and second fulcrum points are defined at opposing ends of a surface that lies obliquely to the longitudinal axis on a side of the fulcrum member facing toward the free end of the working tip, and that slopes away from the free end of the working tip toward the handle moving outwardly away from the elongated shaft.

In the preferred single-fulcrum embodiment, the sloped surface of the fulcrum member is frustoconically contoured.

In the preferred single-fulcrum embodiment, the fulcrum member comprises a cylindrically contoured portion that joins with the sloped surface of the fulcrum member at an end thereof nearest the handle.

In the preferred single-fulcrum embodiment, the sloped surface of the fulcrum member joins with a normal surface of the fulcrum that lies normal to the longitudinal axis at an end of the fulcrum nearest to the free end of the working tip.

In the preferred single-fulcrum embodiment, the normal surface is an annular surface spanning circumferentially around the longitudinal axis.

In the preferred single-fulcrum embodiment, the fulcrum member is removably coupled to the elongated shaft.

In the preferred single-fulcrum embodiment, the fulcrum member has an axial through-bore therein at which the fulcrum member is internally threaded, and the elongated shaft is externally threaded at the second end thereof for threaded coupling with the fulcrum member.

Preferably the working tip is removably coupled to the elongated shaft.

Preferably the working tip has an externally threaded area adjacent an attachment end that lies opposite to the free end of the working tip, and the elongated shaft is hollow and internally threaded at the second end thereof to matingly receive the externally threaded attachment end of the working tip.

Preferably an outer diameter of the working tip is smaller at the externally threaded area than at the hollow socket.

Preferably the outer diameter of the working tip reduces at an annular face of the working tip that faces toward the attachment end of thereof at a location between the externally threaded area and the hollow socket and abuts against the second end of the elongated shaft.

According to another aspect of the invention, there is provided a tool for removing studs from a tire, the tool comprising:

an elongated shaft extending in a longitudinal direction along a longitudinal axis;

a handle attached to the elongated shaft at first end thereof;

a working tip on the elongated shaft at a second end thereof lying opposite the first end in the longitudinal direction;

a hollow socket extending axially into the working tip in the longitudinal direction from a free end of the working tip that lies opposite the handle in the longitudinal direction; and

a fulcrum member protruding outwardly from the elongated shaft at a position adjacent to the working tip and spaced from the free end thereof, the fulcrum member having a sloped surface that lies obliquely to the longitudinal axis on a side of the fulcrum member facing toward the free end of the working tip and slopes away from the free end of the working tip toward the handle moving outwardly away from the elongated shaft.

Preferably the sloped surface of the fulcrum member starts at a radial distance outward from the shaft.

According to yet another aspect of the invention, there is provided a tool for removing studs from a tire, the tool comprising:

an elongated shaft extending in a longitudinal direction;

a handle attached to the elongated shaft at first end thereof;

a working tip on the elongated shaft at a second end thereof lying opposite the first end in the longitudinal direction;

a hollow socket extending axially into the working tip in the longitudinal direction from a free end of the working tip that lies opposite the handle in the longitudinal direction;

a first fulcrum member protruding transversely from the elongated shaft in a first direction and defining a first fulcrum point at a first distance spaced outwardly from the elongated shaft in said first direction; and

a second fulcrum member protruding transversely from the elongated shaft in a different second direction and defining a second fulcrum point at a second distance spaced outwardly from the elongated shaft in said second direction;

wherein, in the longitudinal direction, the first fulcrum point resides nearer to the free end of the working tip than the second fulcrum point.

In a preferred two-fulcrum embodiment, the first fulcrum member comprises a first solid block of material.

In the preferred two-fulcrum embodiment, the first fulcrum point comprises a respective corner edge of the first fulcrum member defined at an intersection of two adjacent facets of the first fulcrum member.

In the preferred two-fulcrum embodiment, one of the two adjacent facets of the first fulcrum member is perpendicular to the shaft and faces toward the free end of the working tip.

In the preferred two-fulcrum embodiment, the two adjacent facets of the first fulcrum member is parallel to the shaft.

In the preferred two-fulcrum embodiment, the first fulcrum member is rectangular in shape.

In the preferred two-fulcrum embodiment, the second fulcrum member comprises a second solid block of material.

In the preferred two-fulcrum embodiment, the second fulcrum point comprises a respective corner edge of the second fulcrum member defined at an intersection of two adjacent facets of said second fulcrum member.

In the preferred two-fulcrum embodiment, one of the two adjacent facets of the second fulcrum member is obliquely oriented relative to the elongated shaft and, moving outwardly away from the shaft in the second direction, slopes away from the free end of the working tip.

In the preferred two-fulcrum embodiment, the other of the two adjacent facets of the second fulcrum member is obliquely oriented relative to the elongated shaft and, moving outwardly away from the shaft in the second direction, slopes toward the free end of the working tip.

In the preferred two-fulcrum embodiment, the second fulcrum member is tapered in the second direction in a manner narrowing away from the elongated shaft toward the second fulcrum point

In the preferred two-fulcrum embodiment, the first and second fulcrum members project outward from the elongated shaft at a same location therealong.

In the preferred two-fulcrum embodiment, the first and second directions in which the first and second fulcrum members protrude are opposite to one another, whereby the first and second fulcrum members reside on opposing sides of the elongated shaft.

In the preferred two-fulcrum embodiment, the first fulcrum member has a thickness that is at least as great as a diameter of one or both of the elongated shaft and the working tip, the thickness being measured perpendicular to the longitudinal direction of the elongated shaft and perpendicular to the first and second directions in which the first and second fulcrum members protrude therefrom.

In the preferred two-fulcrum embodiment, the fulcrum member feature has a thickness that is at least as great as a diameter of one or both of the elongated shaft and the working tip, the thickness being measured perpendicular to the longitudinal direction of the elongated shaft and perpendicular to the first and second directions in which the first and second fulcrum members protrude therefrom.

In the preferred two-fulcrum embodiment, the thickness exceeds the diameter of said one or both of the elongated shaft and the working tip.

In the preferred two-fulcrum embodiment, the thickness is at least as great as the diameter of the elongated shaft.

In the preferred two-fulcrum embodiment, the diameter of the elongated shaft exceeds the diameter of the working tip.

In the preferred two-fulcrum embodiment, the handle has an elongated shape whose greatest dimension lies parallel to the longitudinal direction of the elongated shaft.

In the preferred two-fulcrum embodiment, the first and second fulcrum members are rigidly fixed to said elongated shaft, for example being welded or cast thereto.

According to yet another aspect of the invention, there is provided a method of removing a stud from a tire comprising:

providing the two-fulcrum tool recited above, of which the first fulcrum point is engagable against a notably worn tire to pry the stud therefrom and the second fulcrum point is engagable against a less-worn tread to pry the stud therefrom;

providing a subject tire having either notably worn or less worn tread conditions at a crown of said subject tire, and a subject tire stud to be removed from said subject tire;

fitting the hollow socket of the working tip of the tool over the subject tire stud, and tilting the tool in a respective direction engaging a selected one of the fulcrum members against the crown of the subject tire to pry the subject tire stud from said subject tire.

### BRIEF DESCRIPTION OF THE DRAWINGS

Preferred embodiments of the invention will now be described in conjunction with the accompanying drawings in which:

FIG. 1 is an isometric view of a two-fulcrum tire stud pulling tool of the present invention.

FIG. 2 is a side view of the two-fulcrum tire stud pulling tool.

FIG. 3 is another side view of the two-fulcrum tire stud pulling tool, having been rotated ninety degrees about a longitudinal axis of the tool from the position of FIG. 2.

FIG. 4A is a side view illustrating use of the two-fulcrum tire stud pulling tool on a substantially unworn tire having a notable remaining tread depth.

FIG. 4B is a side view illustrating use of the two-fulcrum tire stud pulling tool on a notably worn tire having a shallower tread depth.

FIGS. 5A and 5B are side views like those of FIGS. 2 and 3, but including dimensions according to one preferred embodiment of the two-fulcrum tire stud pulling tool, in inches.

FIG. 6 is a perspective view of a single-fulcrum stud pulling tool of the present invention.

FIG. 7 is an end view of the single-fulcrum stud pulling tool from a working end thereof.

FIG. 8 is a perspective view of a removable working tip of the single-fulcrum stud pulling tool in isolation.

FIG. 9 is a side view of the removable working tip of FIG. 8 in isolation.

FIG. 10 is a side view of a shaft of the single-fulcrum stud pulling tool in isolation.

FIG. 11 is a perspective view of a fulcrum member of the single-fulcrum stud pulling tool in isolation.

FIG. 12A is a side view illustrating use of the single-fulcrum tire stud pulling tool on a substantially unworn tire having a notable remaining tread depth.

FIG. 12B is a side view illustrating use of the single-fulcrum tire stud pulling tool on a notably worn tire having a shallower tread depth.

FIG. 13 is a side view of the single-fulcrum tire stud pulling tool, including dimensions according to one preferred embodiment thereof.

In the drawings like characters of reference indicate corresponding parts in the different figures.

### DETAILED DESCRIPTION

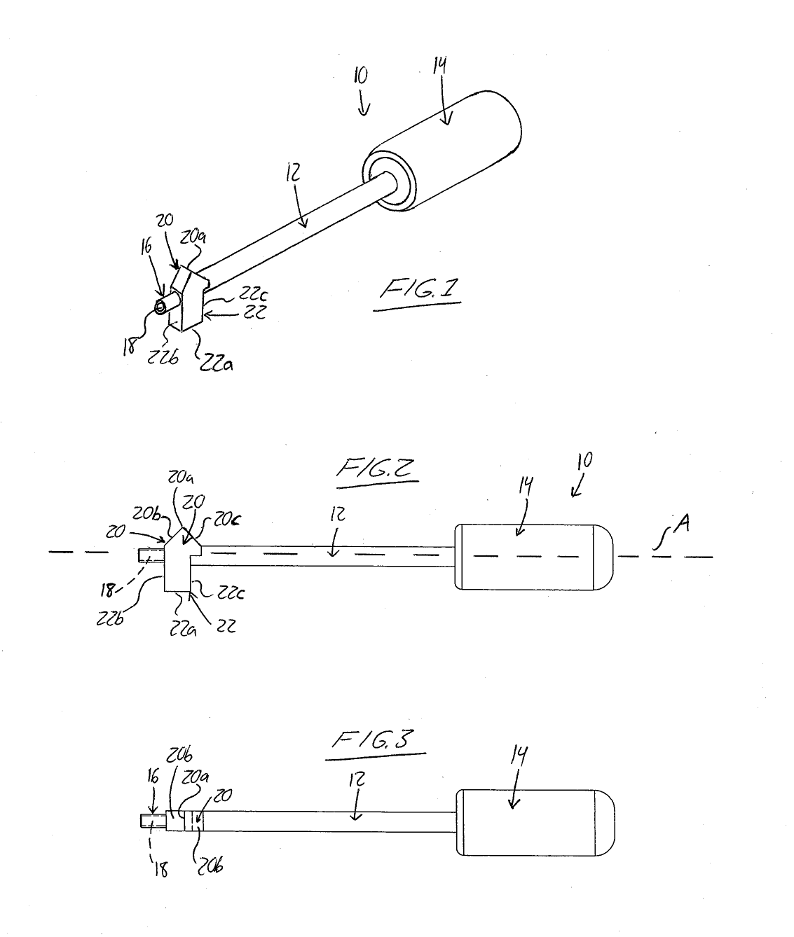

FIGS. 1 to 3 illustrate the physical structure of a two-fulcrum stud pulling tool 10 of the present invention for removing studs from studded winter tires. The tool 10 features an elongated cylindrical shaft 12, a handle 14 fixed to a first end of the shaft 12 in concentric alignment with a central longitudinal axis A thereof, and a cylindrical insert 16 fixed to the shaft 12 at the second end thereof opposite the handle 14. An attachment end of the insert 16 is concentrically received within a hollow cylindrical space that is axially recessed into the shaft 12 at the respective end thereof. The insert 16 is hollow, for example being formed by a short length of steel tubing, whereby the hollow interior of the insert 16 forms a cylindrical socket 18 that recesses axially into the tool from the free end of the insert that lies opposite the handle 14 in the longitudinal direction of the shaft axis A. The handle 14 is elongated in shape in the same direction as the shaft 12, thus forming an in-line handle, similar to that found on a conventional screwdriver.

The first illustrated embodiment features a generally cylindrical handle 14 of circular shape in cross-sectional planes lying perpendicular to the longitudinal axis A, although it will be appreciated that other handle shapes may be employed, for example including handles of square section. Likewise, it will be appreciated that the shaft 12 need not necessarily be of round cylindrical form, and for example may be square in cross-section. The shaft 12 may be formed of solid steel, other metals, or other sufficiently strong material for the intended stud-pulling function. The shaft may be hollow rather than solid, provided again that the resulting overall strength is suitable. In the first illustrated embodiment, the insert 16 forms the working tip of the tool at the end thereof opposite the handle, and is made of hardened steel or other material of greater hardness than the shaft 12 so as to provide improved resistance to wear or damage, thus improving the wear durability and lifespan of the tool. In other embodiments, the working tip may be a hollow, integral extension of the shaft 12 rather than separate component nested partially within a hollow end of the shaft and fixed thereto.

The working tip insert 16 features an external chamfer at the free end thereof, and the axial length and diameter of the internal socket 18 of the insert slightly exceed the shaft length and shaft diameter of a size of tire stud for which the tool is intended to remove, whereby the externally chamfered end of the working tip insert 16 forms a sharpened end that can be forced into the tread of a studded tire around the shaft of tire stud so as to telescopically fit the socket 18 of the insert around the shaft of the embedded tire stud.

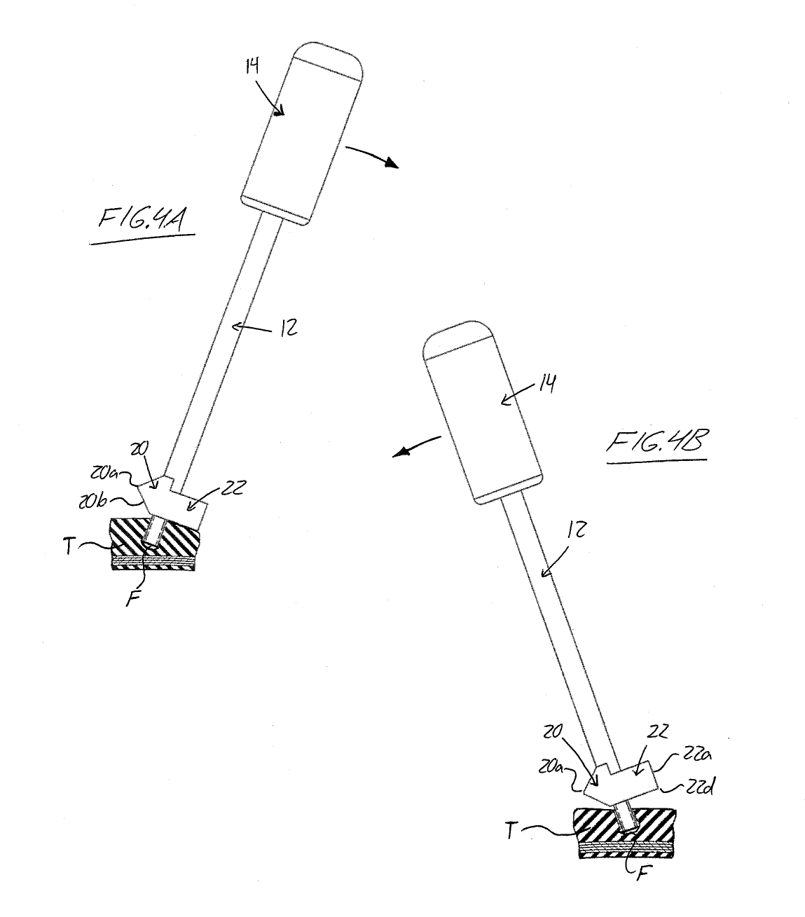

A tapered or pointed fulcrum block 20 is fixed to the exterior of the elongated shaft 12 at the hollowed-out second thereof in which the working tip insert 16 is received, and projects transversely outward from the shaft 12 in a radial direction relative to the longitudinal axis A of the shaft 12. A width dimension of the pointed fulcrum block 20, measured parallel to the longitudinal axis A of the shaft, tapers in a direction moving outward from the shaft, thus giving the first fulcrum block 20 its pointed shape in the side view of FIG. 2. As shown in FIG. 3, a thickness of the first fulcrum block 20 is generally equal to the diameter of the shaft 12. In the illustrated two-fulcrum embodiment, the first fulcrum block 20 has a uniform thickness throughout, thus feature two parallel faces at diametrically opposing sides of the shaft 12. The pointed ends of the planar faces on the opposing sides of the shaft 12 are interconnected at the distal end of the block 20 by a linear corner edge 20a that lies perpendicular to the shaft axis A and perpendicular to the planes of the two parallel faces of the first fulcrum block 20. This corner edge 20a is defined by intersection of two converging side facets 20b, 20c of the pointed fulcrum block 20. These two side facets 20b, 20c are symmetric about a plane that is perpendicular to the shaft axis A and contains the distal edge 20a. Accordingly, these converging side facets 20b, 20c are each obliquely oriented relative to the shaft axis A. Moving away from the shaft, the side facet 20b facing toward the free end of the working tip insert 16 slopes away from the free end of the working tip insert 16 and toward the handle 14. Moving away from the shaft, the side facet 20c facing toward the handle 14 slopes away from the handle 14 and toward the free end of the working tip insert 16.

A rectangular fulcrum block 22 is fixed to the exterior of the elongated shaft 12 at the hollowed-out second thereof in which the working tip insert 16 is received, and projects transversely outward from the shaft 12 in a radial direction opposite that of the first fulcrum block 20. The rectangular fulcrum block 22 is not tapered or pointed like the first block 20, and instead features a planar facet 22a at its distal end. The rectangular fulcrum block 22 in the first illustrated embodiment has a uniform thickness matching that of the pointed block 20, and features parallel opposing faces lying coplanar with those of the pointed block 20. The flat distal end facet 22a lies parallel to the shaft axis and perpendicular to the planes of the parallel faces of the rectangular block 22. Two parallel side facets 22b, 22c of the rectangular block 22 lie perpendicular to the shaft axis A and to the two faces of the rectangular block 22. A linear corner edge 22d of the rectangular block 22 perpendicularly connects the two faces of the block 22 at the intersection between the distal end facet 22a and the one of the side facets 22b that faces toward the free end of the working tip insert 16. This corner edge 22d of the second block thus lies parallel to the distal corner edge 20a of the first block 20.

The width of the rectangular block, measured along the longitudinal shaft axis A between the two parallel sides 22b of the block 22 spans more than half, but less than all, of the width of the pointed block 20 at the wide end thereof that is attached to the shaft 12. As a result, the second corner edge of the rectangular block (defined at the intersection of the flat distal end 22a thereof and the handle-facing side facet 22c) resides nearer to the handle in the longitudinal direction of the shaft axis A than the pointed distal edge 20a of the pointed block 20. With the width of the rectangular block 22 being less than that of the pointed block 20, the rectangular block 22 thus appears to have a cutout area at the side thereof that faces toward the handle 14.

The two fulcrum blocks 20, 22 are rigidly fixed to the shaft 12, for example being solid blocks of steel or other metal welded to the shaft, or cast to or cast with the shaft. In the first illustrated embodiment, the tip-facing side facet 20b of the pointed fulcrum block 20 adjoins with the tip-facing side face 22b of the rectangular fulcrum block 22 at an oblique angle. As a result, the corner edge 22d of the rectangular block 22 defined between the distal facet 22a and the tip-facing side facet 22b resides nearer to the open free end of the working tip insert 16 along the shaft axis A than the distal edge 20a of the pointed block 20. These respective edges 20a, 22d of the two fulcrum blocks 20, 22 define fulcrum points of the tool for engaging against the crown or tread area of a tire in order to serve as a lever fulcrum for prying of a stud from the tire, as described in more below.

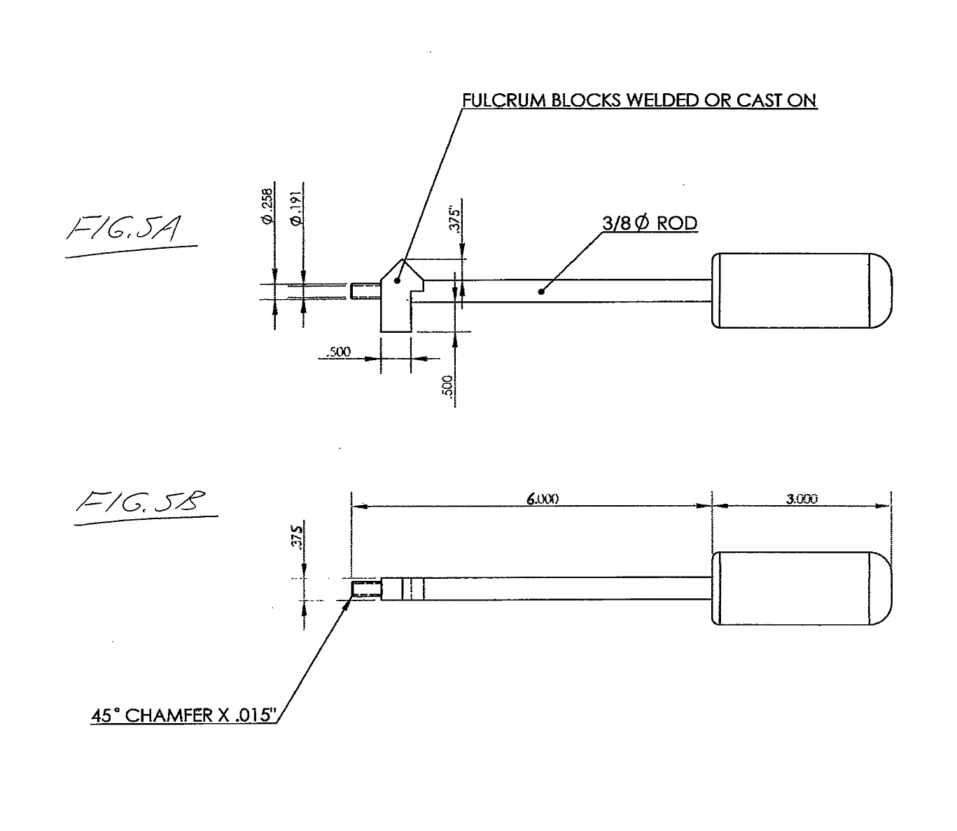

Turning to FIG. 4, to use the tool, the free end of the working tip insert 16 is aligned over the tip of a tire stud that protrudes radially outward from the crown of the tire. The free end of the working tip insert 16 is then forced into the tire tread, whereby the hollow working tip insert 16 slides down over the shaft of the tire stud into a position abutting the anchoring flange F of the tire stud that is embedded within the tire rubber. With particular reference to FIG. 4A, if the tire T is not overly worn, and thus has a notable tread depth remaining, then the handle 14 is tilted by the operator to the side thereof on which the rectangular fulcrum block 22 is defined in order to use the corner edge 22d thereof as a fulcrum against the tire tread to pry the stud from the tire. On the other hand, with reference to FIG. 4B, if the tire T is worn down to a notably shallower tread depth, the handle 14 is instead tilted by the operator to the side thereof on which the pointed fulcrum block 20 is defined in order to use the distal edge 22a thereof as the fulcrum point for the prying action.

Since the fulcrum point 22d on the rectangular block 22 is positioned closer to the working tip of the tool that engages over the tire stud, the use of the rectangular fulcrum block 22 on the less worn tire T of FIG. 4A means that the fulcrum point 22d will make initial contact with the tire tread T earlier in the tilting action than would occur if the tool were tilted in the other direction to employ the fulcrum point 20a on the pointed fulcrum block 20. The unworn tread will have a greater degree of flexibility than the more worn tread of FIG. 4B, and so this earlier point of tread contact by fulcrum point 22d starts to compress the resilient rubber tread. As the tilt angle of the tool increases, the compression of the tread will reach a point at which it compresses no further, whereby the fulcrum point 22d now acts as a lever fulcrum in order to pry the stud out of the tire.

With reference to FIG. 4B, if the tire tread is notably worn, the exposed surface of the tread is harder (i.e. less compressible in the radial direction of the tire), whereby if the rectangular fulcrum block 22 were used, the transition from a compression action to a lever action at the fulcrum block's contact point 22d with the tire tread would be too early, where the working tip of the tool would be acting to force force the stud against the side of its cavity in the tire rubber, rather than prying it upward (i.e. radially outward) from the cavity. Accordingly, the pointed block 20 is instead used on the worn tread, where the positioning of the fulcrum point 20a further from the working tip of the tool means that the shaft axis A of the tool will hit a greater degree of tilt from the tool's original insertion orientation before the fulcrum point 20a engages the tire tread and begins the levered action, whereby the tool orientation at the initiation of the tool's levering action will provide the working tip of the tool with a sufficient radial direction of action (relative to the tire) to pry the stud from its cavity.

Accordingly, the use of differently positioned fulcrum points on different sides of the tool renders the same tool effective on tires of notably different tread level.

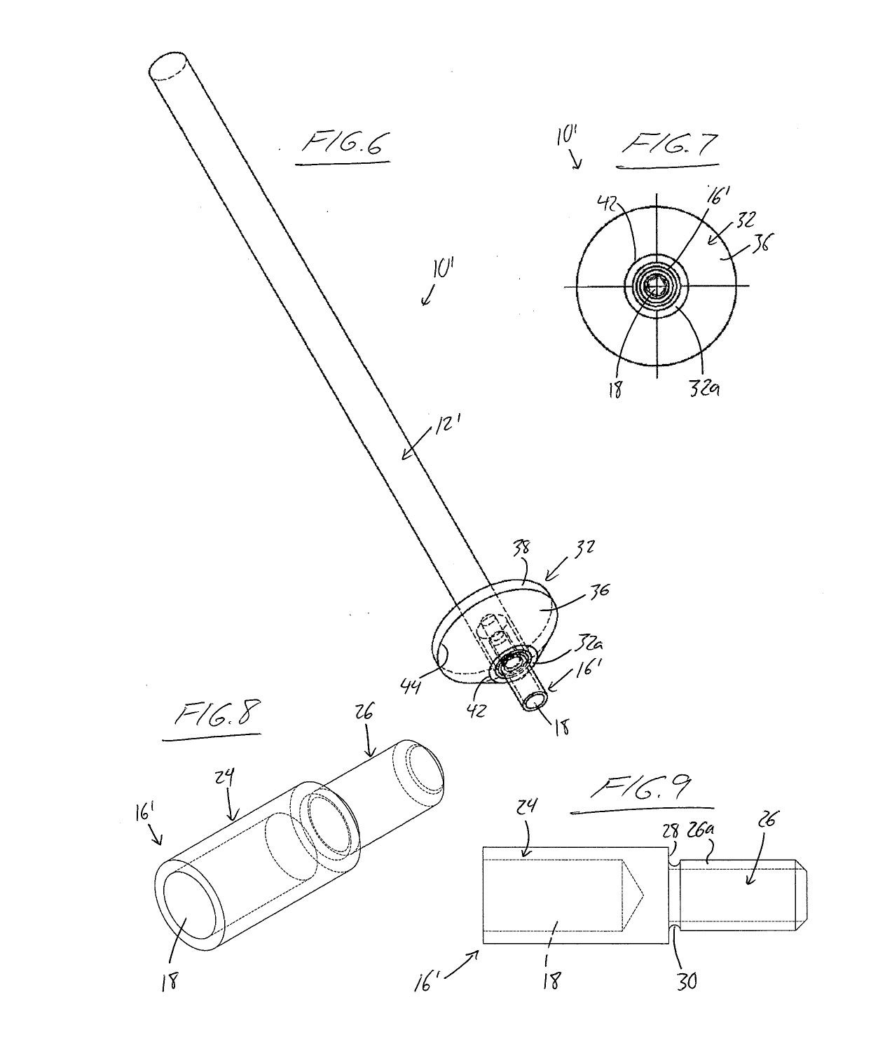

FIG. 5 shows dimensions of one two-fulcrum embodiment of the present invention, but it will be appreciated that the illustrated dimensions may be varied within the scope of the present invention.

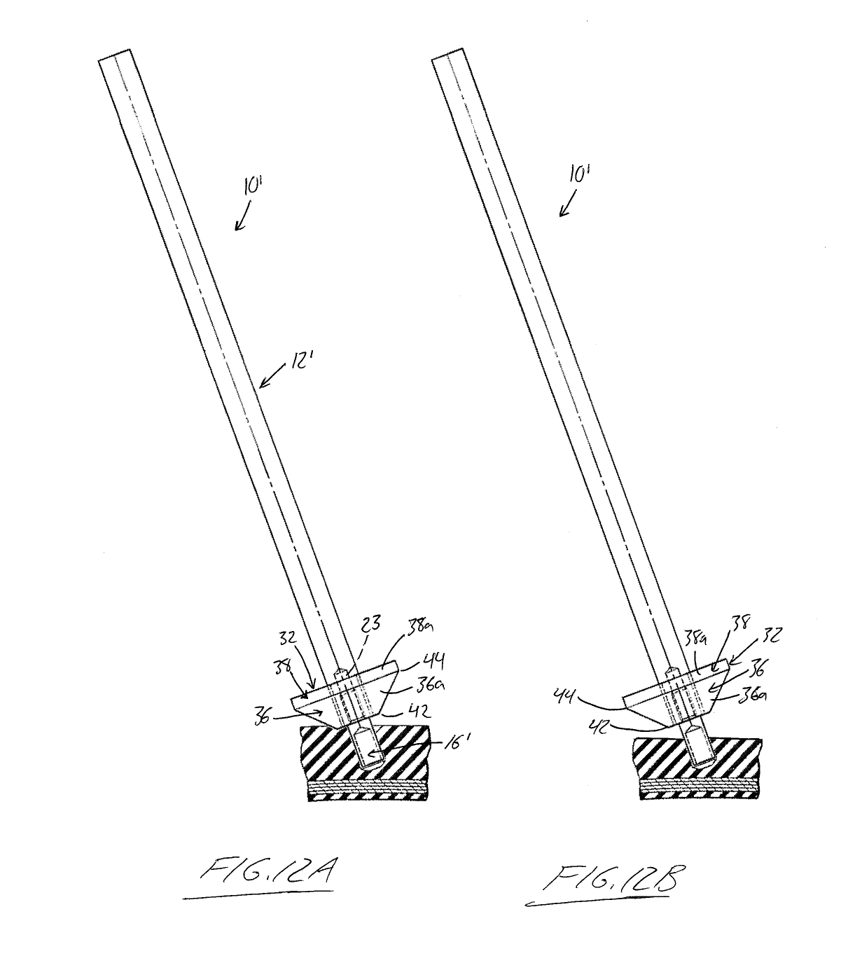

FIGS. 6 through 10 illustrate a second embodiment of the present invention which employs a singular fulcrum member spanning around the full circumference of the shaft instead of two distinct fulcrum members projecting from diametrically opposing sides of the shaft. The handle of the two-fulcrum embodiment has been omitted from the drawings for illustrative simplicity, but it will be appreciated that the tool is preferably equipped with a suitable handle, such as that described and illustrated for the two-fulcrum embodiment of FIGS. 1 to 5.

The two-fulcrum tool 10′ once again features an elongated cylindrical shaft 12′ having a first end 12a for joining with the unillustrated handle, and a second end 12b to which a working tip insert 16′ is attached. The attachment end of the insert 16 is concentrically received within a hollow cylindrical space 23 that is axially recessed into the shaft 12 at the respective end thereof, which in the present embodiment is a threaded bore defining internal threads of the shaft 12′ for engagement with mating external threads on the attachment end of the working tip insert 16′. In the present embodiment, the threaded working tip insert 16′ is therefore removable from the shaft for convenient replacement if required.

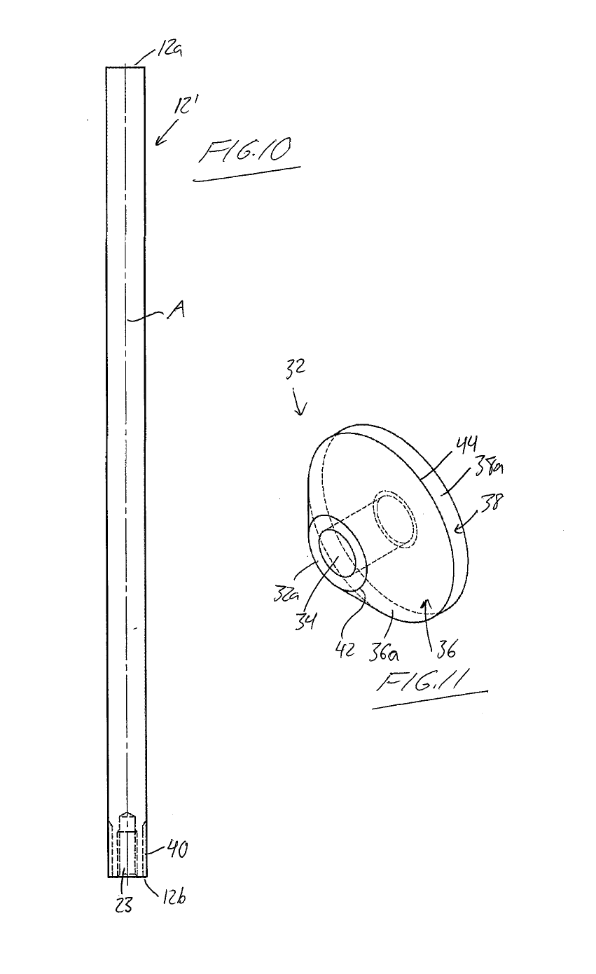

With reference to FIGS. 8 and 9, the working tip insert 16′ of the second illustrated embodiment features a first generally cylindrical portion 24 which defines the free end of the insert in which the socket 18 is axially recessed, and a second generally cylindrical portion 26 that defines the externally threaded attachment end that lies opposite to the free end in the axial direction. The external threading 26a is represented only schematically in FIG. 9. The outer diameter of the working tip insert 16 is smaller at the externally threaded portion 26 than at the hollow socket portion 24. The diameter of the working tip insert 16′ steps downwardly at an annular face 28 that is located at the end of the hollow socket portion 24 that faces toward the attachment end of the insert 16′. A radiused neck 30 is provided between the annular end face 28 of the hollow socket portion 24 and the externally threaded portion 26 in order to reduce stress concentrations at the transition between the two portions of different outer diameter. When the externally threaded portion 26 of the working tip insert 16′ is fully advanced into the threaded bore 23 of the shaft 12′, the annular face 28 of the working tip insert 16′ abuts against the second end 12b of the shaft 12′, thereby defining a stop that limits the insertion of the working tip 16′ and defines the fully seated or installed position thereof.

The present embodiment features a singular fulcrum member 32 instead of the two different fulcrum members of the first illustrated embodiment. The fulcrum member 32 is a solid body of metal or other hard material having an axial bore 34 passing fully therethrough at a center of the body. The body features a frustoconical portion 36 and an axially-shorter cylindrical portion 38 of lesser axial length than the frustoconical portion 36. The shorter cylindrical portion 38 has the same diameter as the wide end of the frustoconical portion 36, and is integrally and seamlessly joined thereto. The central through-bore 34, frustoconical portion 36 and cylindrical portion 38 all share the same common central axis, which aligns with the central longitudinal axis of the shaft 12′ when the fulcrum member 32 is installed thereon. The central through-bore 34 of the fulcrum member is threaded, whereby these internal threads of the fulcrum member are matable with external threads 40 defined on the shaft 12′ at the second end 12b thereof. The fulcrum member 32 is threaded onto the shaft 12′ cylindrical portion first so that the cylindrical portion 38 resides nearer to the first end 12a of the shaft than the frustoconical portion 36. The threaded connection between the shaft 12′ and the fulcrum member 12 bottoms out at or near the point at which the narrow end of the frustoconical portion 36 lies flush with the second end 12b of the shaft.

The outer diameter of the working tip insert 16′, even at the largest diameter area thereof at the hollow socket portion, is smaller than the inner diameter of the fulcrum (as defined by the threaded central bore 34 thereof), whereby the fulcrum can be installed and removed independently of the working tip insert 16′, and the stop face 28 of the installed working tip insert 16′ abuts against the second end of the shaft 12b, but not against the narrower annular end 32a of the fulcrum 32 that faces toward the free end of the installed working tip insert.

With the fulcrum 32 installed, the peripheral outer surface 36a of the frustoconical portion 36 faces toward the free end of the working tip insert 16′ and lies at an oblique angle relative to the longitudinal axis A of the shaft 12′ so as to slope away from the free end of the working tip insert 16′ toward the opposing first end 12a of the shaft 12a in a direction radiating outwardly from the shaft 12′. The narrow end 32a of the fulcrum member 32 features a planar annular surface residing in a plane normal to the longitudinal axis A of the shaft 12′, and radiating outwardly from the shaft 12′ before joining up with the frustoconically contoured peripheral surface 36a of the fulcrum member 32. Accordingly, the fulcrum member first extends perpendicularly outward from the shaft at its narrow lower end 32a before turning obliquely upwardly toward the handle-end 12a of the shaft 12′ at its frustoconical peripheral surface 36a, thereby forming a first corner edge 42 between the normal annular end surface 32a of the fulcrum member and the obliquely sloped frustoconical surface 36a thereof. A second corner edge 44 situated further toward the handle-end of the shaft along the longitudinal axis A thereof, and situated further radially outward from the shaft than the first corner edge 42, is defined at the transition between the peripheral surfaces of the frustoconical and cylindrical portions 36, 38 of the fulcrum member 32. These two corner edges 42, 44 define respective fulcrum points situated at opposing ends of the sloped frustoconcial surface 36a.

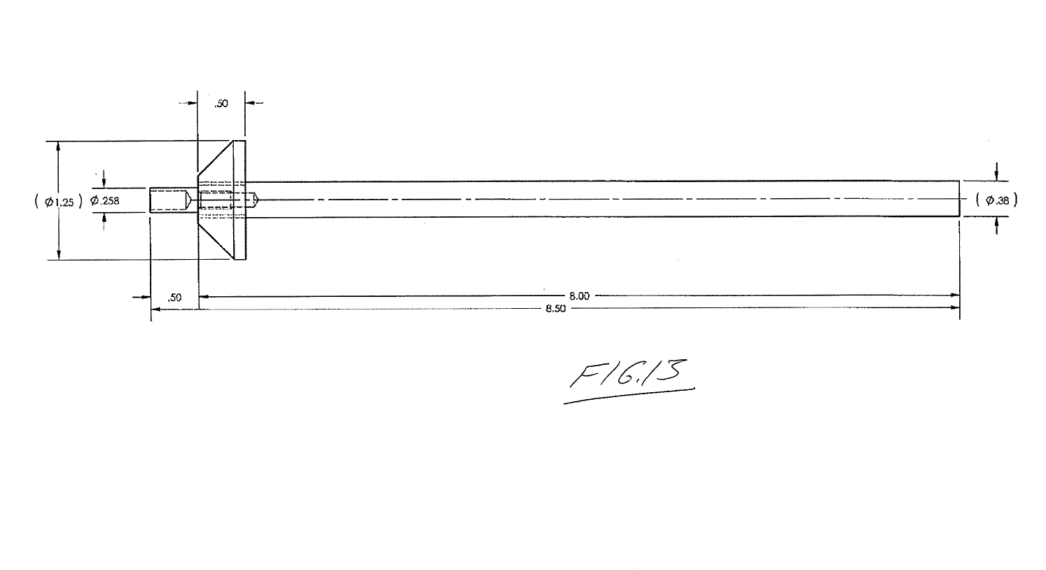

FIG. 12A shows use of the single-fulcrum tool on a substantially intact tire with zero or minimal tread wear. As described for the first embodiment, the free end of the working tip insert 16′ is forced into the tire tread, whereby the hollow working tip insert 16′ slides down over the shaft of the tire stud into a position abutting the anchoring flange F of the tire stud that is embedded within the tire rubber. The shaft 12′ is tilted by the operator via the handle (not shown) in order to use the first corner edge 42 of the fulcrum member 32 as a fulcrum point against the tire tread to pry the stud from the tire. Since the frustoconically contoured fulcrum member 32 circumferentially surrounds the entirety of the shaft 12′, and has a uniform cross-sectional shape in all cross-sectional planes containing the longitudinal axis A of the shaft, the tool can be tilted in any direction to perform this prying action.

FIG. 12B shows use of the single-fulcrum tool on a tire T that has been worn down to a notably shallower tread depth. The same initial process of fitting the working tip insert over the shaft of the tire stud and tilting the shaft of the tool is performed, as described above for FIG. 12A. However, because of the shallower tread depth, the first corner edge 42 of the fulcrum 32 is spaced further above the tread, and so bringing the tool into the same angle of tilt that engaged the first corner edge 42 with the tread of an unworn tire fails to bring the first corner edge into contact with the worn tire tread, as apparent from a side-by-side viewing of FIGS. 12A and 12B. Instead, the tool is tilted to a greater angle until the frustoconical surface 36a is brought into contact with the tread, at which point the second corner edge 44 at the outer end of the frustoconical surface 36a serves as a fulcrum point to initiate the prying action on the tire stud.

The single-fulcrum embodiment is thus similar to the two-fulcrum embodiment in that it features two fulcrum points, one of which resides axially nearer to the free end of the working tip insert than the other, but differs in that its two fulcrum points (first corner edge 42, and second corner edge 44) are defined by a singular fulcrum member spanning fully around the shaft, rather than being defined by two distinctly different fulcrum members projecting in opposite radial directions from the shaft. The second illustrated embodiment with a single fulcrum may be easier and more affordable to manufacture than the first illustrated embodiment with its two different fulcrum members, and has the advantage that it can be tilted in any direction regardless of the tread wear of the given tire, as the first and second fulcrum points for unworn and worn tire treads are present at all locations around the shaft.

While the illustrated single-fulcrum embodiment features a substantially frustoconical fulcrum member that spans around the full circumference of the shaft so that the elongated shaft can be tilted in any direction to initial the stud-prying action, other embodiments may likewise have a singular fulcrum member with a sloped surface that faces toward the free end of the working tip and extends between first and second corner edges that are spaced at different first and second radial distances outward from the shaft at different first and second axial distances from the free end of the working tip insert, regardless of whether the fulcrum member circumferentially surrounds the shaft or merely projects outward to one side thereof like the fulcrums of the earlier two-fulcrum embodiment. While the illustrated single-fulcrum embodiment employs a removable working tip insert and removable fulcrum member, the working tip and/or the fulcrum member may be permanently affixed to the shaft in other embodiments. However, use of removable components enables replacement of damaged components, or substitution of differently sized components, for example working tips inserts of different socket sizes to accommodate different sizes of tire stud.

Since various modifications can be made in my invention as herein above described, and many apparently widely different embodiments of same made within the scope of the claims without departure from such scope, it is intended that all matter contained in the accompanying specification shall be interpreted as illustrative only and not in a limiting sense.

1. A tool for removing studs from a tire, the tool comprising:
an elongated shaft extending in a longitudinal direction along a longitudinal axis;
a handle attached to the elongated shaft at first end thereof;
a working tip on the elongated shaft at a second end thereof lying opposite the first end in the longitudinal direction;
a hollow socket extending axially into the working tip in the longitudinal direction from a free end of the working tip that lies opposite the handle in the longitudinal direction;
a first fulcrum point carried on the shaft at a first radial distance outward from the shaft and at a first axial distance in the longitudinal direction from the free end of the working tip; and
a second fulcrum point carried on the shaft at a second radial distance outward from the shaft and at a second axial distance in the longitudinal direction from the free end of the working tip, the second axial distance between greater than the first axial distance so as to situate the second fulcrum point further form the free end of the working tip than the first fulcrum point.

2. The tool of claim 1 wherein each fulcrum point is defined by a corner edge defined between two surfaces of a fulcrum member attached to the shaft.

3. The tool of claim 1 wherein the first and second fulcrum points are defined by a same fulcrum member attached to the shaft.

4. The tool of claim 3 wherein the fulcrum member spans circumferentially around the elongated shaft.

5. The tool of claim 3 wherein the first and second fulcrum points are defined at opposing ends of a surface that lies obliquely to the longitudinal axis on a side of the fulcrum member facing toward the free end of the working tip, and that slopes away from the free end of the working tip toward the handle moving outwardly away from the elongated shaft.

6. The tool of claim 5 wherein the sloped surface of the fulcrum member is frustoconically contoured.

7. The tool of claim 5 wherein the fulcrum member comprises a cylindrically contoured portion that joins with the sloped surface of the fulcrum member at an end thereof nearest the handle.

8. The tool of claim 5 wherein the sloped surface of the fulcrum member joins with a normal surface of the fulcrum that lies normal to the longitudinal axis at an end of the fulcrum nearest to the free end of the working tip.

9. The tool of claim 8 wherein the normal surface is an annular surface spanning circumferentially around the longitudinal axis.

10. The tool of claim 3 wherein the fulcrum member is removably coupled to the elongated shaft.

11. The tool of claim 10 wherein the fulcrum member has an axial through-bore therein at which the fulcrum member is internally threaded, and the elongated shaft is externally threaded at the second end thereof for threaded coupling with the fulcrum member.

12. The tool of claim 1 wherein the working tip is removably coupled to the elongated shaft.

13. The tool of claim 12 wherein the working tip has an externally threaded area adjacent an attachment end that lies opposite to the free end of the working tip, and the elongated shaft is hollow and internally threaded at the second end thereof to matingly receive the externally threaded attachment end of the working tip.

14. The tool of claim 13 wherein an outer diameter of the working tip is smaller at the externally threaded area than at the hollow socket.

15. The tool of claim 13 wherein the outer diameter of the working tip reduces at an annular face of the working tip that faces toward the attachment end of thereof at a location between the externally threaded area and the hollow socket and abuts against the second end of the elongated shaft.

16. A tool for removing studs from a tire, the tool comprising:
an elongated shaft extending in a longitudinal direction along a longitudinal axis;
a handle attached to the elongated shaft at first end thereof;
a working tip on the elongated shaft at a second end thereof lying opposite the first end in the longitudinal direction;
a hollow socket extending axially into the working tip in the longitudinal direction from a free end of the working tip that lies opposite the handle in the longitudinal direction; and
a fulcrum member protruding outwardly from the elongated shaft at a position adjacent to the working tip and spaced from the free end thereof, the fulcrum member having a sloped surface that lies obliquely to the longitudinal axis on a side of the fulcrum member facing toward the free end of the working tip and slopes away from the free end of the working tip toward the handle moving outwardly away from the elongated shaft.

17. The tool of claim 16 wherein the sloped surface of the fulcrum member starts at a radial distance outward from the shaft.

18. The tool of claim 16 wherein the fulcrum member spans circumferentially around the elongated shaft.

19. The tool of claim 16 wherein the sloped surface of the fulcrum member is frustoconically contoured.

20. The tool of claim 16 wherein the sloped surface of the fulcrum member joins with a normal surface of the fulcrum that lies normal to the longitudinal axis at an end of the fulcrum nearest to the free end of the working tip.
